(19) United States
(12) Patent Application Publication
(10) Pub. No.: US 2009/0292135 A1
(43) Pub. Date: Nov. 26, 2009

(54) ORGANOMETAL BENZENEPHOSPHONATE COUPLING AGENTS

(75) Inventors: Timothy C. Barden, Salem, MA (US); Peter Lee, Herndon, VA (US); Eduardo J. Martinez, St. Louis, MO (US); Wayne C. Schairer, Westboro, MA (US); John J. Talley, Somerville, MA (US); JingJing Yang, Boxborough, MA (US)

Correspondence Address: HESLIN ROTHENBERG FARLEY & MESITI PC, 5 COLUMBIA CIRCLE, ALBANY, NY, 12203, US

(73) Assignee: Ironwood Pharmaceuticals, Inc., Cambridge, MA (US)

(21) Appl. No.: 11/914,025

(22) PCT Filed: May 9, 2006
(86) PCT No.: PCT/US2006/017914

§ 371 Date: May 22, 2008

Related U.S. Application Data
(60) Provisional application No. 60/678,998, filed on May 9, 2005.

(51) Int. Cl. C07F 9/02; C07F 5/02

(52) U.S. Cl. 556/405; 568/2; 568/14

(57) ABSTRACT

The invention relates to chemical genera of organometal benzenephosphonates useful in cross-coupling organic synthesis, having general formula:

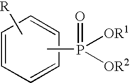

where R is selected from boron, zinc, tin and silicon residues.

### FIELD OF THE INVENTION

The invention relates to chemical genera of organometal benzenephosphonate compounds useful as coupling agents in organic synthesis.

### BACKGROUND OF THE INVENTION

The formation of carbon-carbon bonds is fundamental to organic synthesis and metal-catalyzed cross-coupling reactions have become routine for the chemist. The Suzuki, Stille and Negishi coupling reactions are routinely carried out by coupling an organometallic nucleophile and an organic electrophile in a metal-catalyzed reaction.

U.S. Pat. No. 6,867,323 teaches a method for generating carbon-carbon bonds comprising reacting an organosilicon reagent with an organic electrophile, in the presence of a basic and nucleophilic activator anion and a Group 10 metal catalyst.

The use of cross coupling methodologies is limited by the availability of organometallic reagents.

### SUMMARY OF THE INVENTION

The present invention provides metalobenzenephosphonates useful for preparing biphenylylphosphonates by cross coupling. The resulting biphenylylphosphonates are useful as cholesterol absorption inhibitors. (See copending U.S. application Ser. No. 10/986,570.)

In one aspect the invention relates to compounds of formula I:

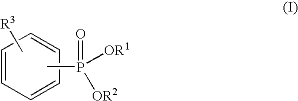

wherein
R¹ and R² are independently selected from H, (C₁-C₆) alkyl, phenyl, benzyl, Group 1 salts, Group 2 salts, and ammonium salts; and
R³ is selected from the group consisting of
ZnX wherein X is a halogen; and
B(OR⁴)(OR⁵), wherein R⁴ and R⁵ are independently selected from H and (C₁-C₆) alkyl, or R⁴ and R⁵ together form a 5-6 membered ring.

In another aspect the invention relates to compounds of formula II:

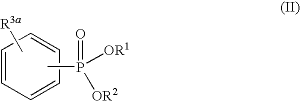

wherein
R¹ and R² are independently selected from H, (C₁-C₆) alkyl, benzyl and phenyl; and
R^{3a} is Sn(R¹⁰)(R¹¹)(R¹²) wherein R¹⁰, R¹¹ and R¹² are each (C₁-C₈) alkyl.

In another aspect the invention relates to compounds of formula III:

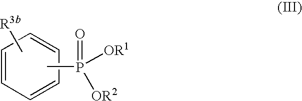

wherein
R¹ and R² are independently selected from H, (C₁-C₆) alkyl, benzyl and phenyl; and
R^{3b} is Si(R¹³)(R¹⁴)(R¹⁵) wherein R¹³ is OH or (C₁-C₆) alkoxy; R¹⁴ and R¹⁵ are independently selected from H, OH, (C₁-C₆) hydrocarbon and (C₁-C₆) alkoxy; with the proviso that when R¹ and R² are both CH₂CH₃, then R¹³, R¹⁴ and R¹⁵ are other than ethyloxy.

In yet another aspect the invention relates to compounds of formula IV:

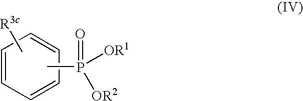

wherein
R¹ and R² are independently selected from H, (C₁-C₆) alkyl, benzyl and phenyl; and
R^{3c} is [Si(R¹⁶)(R¹⁷)(R¹⁸)X]⁻M⁺ wherein R¹⁶ is OH or (C₁-C₆) alkoxy; R¹⁷ and R¹⁸ are independently selected from H, OH, (C₁-C₆) hydrocarbon and (C₁-C₆) alkoxy; X is selected from the group consisting of F, OAc, OR, OSiCH₃; M⁺ is a counterion and R is selected from (C₁-C₆) alkyl. In certain embodiments, X is F. In other embodiments, X is OR. In certain embodiments thereof R is methyl.

In another aspect, the invention relates to compounds of formula compound of formula V:

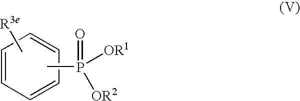

wherein
R¹ and R² are independently selected from H, (C₁-C₆) alkyl, benzyl and phenyl; and
R^{3e} is [Sn(R¹⁹)(R²⁰)(R²¹)X]⁻M⁺ wherein R¹⁹, R²⁰ and R²¹ are independently selected from (C₁-C₈) alkyl and X is selected from the group consisting of halogen, OAc, OR, and OSiCH₃ wherein R is selected from (C₁-C₆) alkyl and M⁺ is a counterion. In certain embodiments, X is F. In other embodiments X is OR. In certain embodiments thereof R is methyl.

In another aspect, the invention relates to methods of generating a carbon-carbon bond, comprising
reacting a compound of formula I, II, III, IV, or V with an organic electrophile selected from an aryl halide, aryl triflate and aryl sulfonate;
   in the presence of a metal catalyst selected from a Group 8, Group 9 and Group 10 metal. In certain embodiments, the invention further comprises recovering a compound comprising said carbon-carbon bond.

In some embodiments the metal catalyst is a Group 10 metal. In other embodiments the Group 10 metal catalyst is selected from nickel, platinum and palladium. In specific embodiments the Group 10 metal catalyst is palladium.

These and other embodiments of the present invention will become apparent in conjunction with the description and claims that follow.

### DETAILED DESCRIPTION OF THE INVENTION

The present invention relates to benzenephosphonate derivatives useful for the formation of carbon-carbon bonds in cross-coupling reactions.

The present invention provides compounds of the genus represented by formula I:

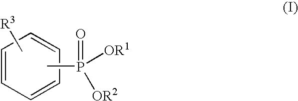

wherein
R¹ and R² are independently selected from H, (C₁-C₆) alkyl, benzyl, phenyl, Group 1 salts, Group 2 salts, and ammonium salts;
R³ is selected from the group consisting of
ZnX wherein X is halogen; and
B(OR⁴)(OR⁵), wherein R⁴ and R⁵ are independently selected from H and (C₁-C₆) alkyl, or R⁴ and R⁵ together form a 5-6 membered ring.

Throughout this specification the terms and substituents retain their definitions.

This genus may be conveniently subdivided into two subgenera having general formulae IA and IB, according to selection of the R³ residue; having chemical formulae shown below:

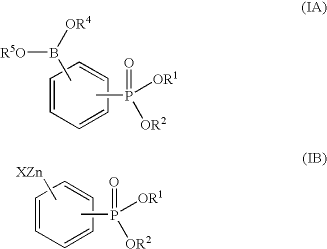

Subgenus IA comprises boronic acid benzenephosphonate derivatives where R¹ and R² are independently selected from H, (C₁-C₆) alkyl, benzyl, phenyl, Group 1 salts, Group 2 salts, and ammonium salts; and R⁴ and R⁵ are H, of formula:

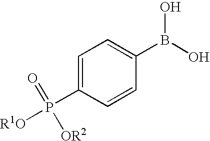

An embodiment in which R¹, R², R⁴ and R⁵ are H is 4-phosphonate phenylboronic acid, of formula:

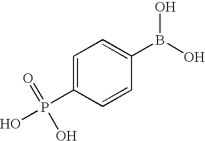

Subgenus IA further comprises dioxaborole benzenephosphonic acid derivatives where R¹ and R² are independently selected from H, (C₁-C₆) alkyl, benzyl and phenyl; and R⁴ and R⁵ together form a 5- or 6-membered ring.

In some embodiments R⁴ and R⁵ together form a 5-membered ring having chemical formula shown below:

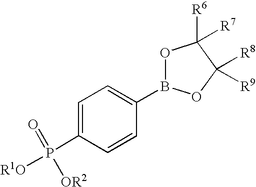

wherein R⁶, R⁷, R⁸ and R⁹ are independently selected from H and (C₁-C₆) alkyl.

In some embodiments R⁴ and R⁵ together form a 5-membered ring; and R¹, R², R⁶, R⁷, R⁸ and R⁹ are methyl, having chemical formula shown below:

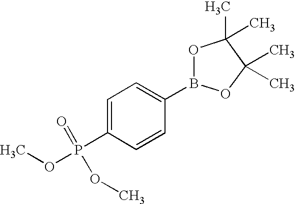

In other embodiments R⁴ and R⁵ together form a 5-membered saturated ring; R¹ and R² are H; and R⁶, R⁷, R⁸ and R⁹ are methyl, having chemical formula shown below:

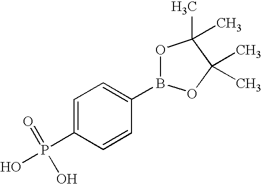

In other embodiments R⁴ and R⁵ form a six-membered ring having chemical formula shown below:

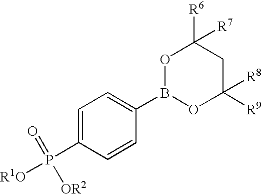

wherein R⁶, R⁷, R¹ and R⁹ are independently selected from H and (C₁-C₆) alkyl.

In some embodiments R⁴ and R⁵ form a six-membered ring, having chemical formula shown below:

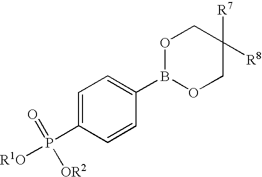

wherein R⁷ and R⁸ are independently selected from H and (C₁-C₆) alkyl.

In one embodiment, R¹ and R² are ethyl and R⁷ and R⁸ are methyl, having chemical formula shown below:

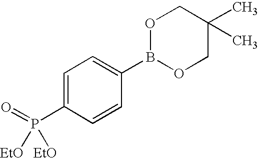

Subgenus IB comprises zinc benzenephosphonic acid derivatives wherein R¹ and R² are CH₃ and X is a halogen of formula:

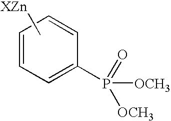

In some embodiments X is I. In other embodiments X is F, Br or Cl.

The present invention also provides salts of the compounds of formulae IA and IB, in which R¹ and R² may be Li, Na, K, Cs, Mg, Ca or ammonium salts, such as tetrabutylammonium and trimethylbenzylammonium.

Genus II comprises benzenephosphonate tin derivatives, of formula:

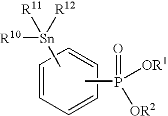

In certain embodiments R¹ and R² are selected from H, CH₃ and CH₂CH₃. In some embodiments R¹⁰, R¹¹ and R¹² are butyl. In other embodiments R¹⁰, R¹¹ and R¹² are methyl.

In some embodiments R¹ and R² is ethyl and R¹⁰, R¹¹ and R¹² are n-butyl having chemical formula shown below:

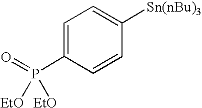

Genus III comprises benzenephosphonate silicon derivatives of formula:

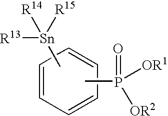

In certain embodiments R¹ and R² are selected from H, methyl and ethyl.

In some embodiments R¹³, R¹⁴ and R¹⁵ are OCH₃. In other embodiments R¹³ and R¹⁴ are OCH₃; and R¹⁵ is CH₃. In yet other embodiments R¹³ and R¹⁴ are CH₃; and R¹⁵ is OCH₃.

In certain embodiments R¹ and R² are ethyl; R¹³ is OH; and R¹⁴ and R¹⁵ are methyl, having chemical formula shown below:

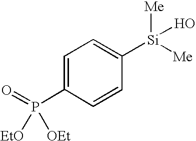

Genus IV comprises hypervalent fluorosilicon benzenephosphonate intermediates of formula:

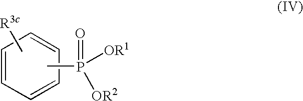

wherein
R¹ and R² are independently selected from H, (C₁-C₆) alkyl, benzyl and phenyl; and
R^{3c} is [Si(R¹⁶)(R¹⁷)(R¹⁸)X]⁻M⁺ wherein R¹⁶ is OH or (C₁-C₆) alkoxy; R¹⁷ and R¹⁸ are independently selected from H, OH, (C₁-C₆) hydrocarbon and (C₁-C₆) alkoxy; X is selected from the group consisting of F, OAc, OR, OSiCH₃; M⁺ is a counterion and R is selected from (C₁-C₆) alkyl.

In some embodiments R¹⁶, R¹⁷ and R¹⁸ are OCH₃. In other embodiments R¹⁶ is OCH₃; and R¹⁷ and R¹⁸ are CH₃. In certain embodiments, X is F. In other embodiments, X is OR. In certain embodiments thereof R is methyl.

Genus V comprises halogenotin benzenephosphonates of formula:

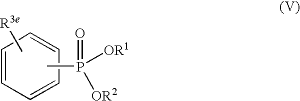

wherein
R¹ and R² are independently selected from H, (C₁-C₆) alkyl, benzyl and phenyl; and
R^{3e} is [Sn(R¹⁹)(R²⁰)(R²¹)X]⁻M⁺ wherein R¹⁹, R²⁰ and R²¹ are independently selected from (C₁-C₈) alkyl; and X is selected from the group consisting of halogen, OAc, OR, and OSiCH₃ wherein R is selected from (C₁-C₆) alkyl and M⁺ is a counterion.

In one embodiment, R¹⁹, R²⁰ and R²¹ are C₄H₉. In certain embodiments, X is F. In other embodiments X is OR. In certain embodiments thereof R is methyl.

The present invention also relates to methods of generating a carbon-carbon bond, comprising
reacting a compound of formula I, II, III, IV, or V with an organic electrophile selected from an aryl halide, aryl triflate and aryl sulfonate;
in the presence of a metal catalyst selected from a Group 8, Group 9 and Group 10 metal.
In certain embodiments the method further comprises recovering a compound comprising said carbon-carbon bond.

In some embodiments the metal catalyst is a Group 10 metal. In other embodiments the Group 10 metal catalyst is selected from nickel, platinum and palladium. In specific embodiments the Group 10 metal catalyst is palladium.

Thus, the invention relates to methods of generating a carbon-carbon bond, comprising

a) reacting a organometal benzenephosphonate compound of formula

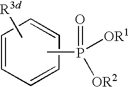

wherein
R¹ and R² are independently selected from H, (C₁-C₆) alkyl, benzyl and phenyl;
and R^{3d} is Si(R¹⁹)(R²⁰)(R²¹) wherein R¹⁹ is OH or (C₁-C₆) alkoxy; and R²⁰ and R²¹ are independently selected from H, (C₁-C₆) hydrocarbon and (C₁-C₆) alkoxy;
with an organic electrophile selected from an aryl halide, aryl triflate and aryl sulfonate;
in the presence of a metal catalyst selected from a Group 8, Group 9 and Group 10 metal. In certain embodiments, the method further comprises recovering a compound comprising said carbon-carbon bond.

In some embodiments R¹⁹, R²⁰ and R²¹ are OCH₃. In other embodiments R¹⁹ and R²⁰ are OCH₃; and R²¹ is CH₃. In yet other embodiments R¹⁹ is OCH₃ and R²⁰ and R²¹ are CH₃. In some embodiments the metal catalyst is a Group 10 metal. In other embodiments the Group 10 metal catalyst is selected from nickel, platinum and palladium. In specific embodiments the Group 10 metal catalyst is palladium.

Thus, the invention relates to methods of generating a carbon-carbon bond, comprising

a) reacting a compound of formula

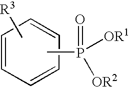

wherein
R¹ and R² are independently selected from H, (C₁-C₆) alkyl, phenyl, benzyl, Group 1 salts, Group 2 salts, and ammonium salts;
R³ is selected from the group consisting of
ZnX wherein X is halogen; and
B(OR⁴)(OR⁵), wherein R⁴ and R⁵ are independently selected from H and (C₁-C₆) alkyl, or R⁴ and R⁵ together form a 5-6 membered ring;
with an organic electrophile selected from an aryl halide, aryl triflate and aryl sulfonate;
in the presence of a metal catalyst selected from a Group 8, Group 9 and Group 10 metal.

In certain embodiments, the method further comprises recovering a compound comprising said carbon-carbon bond.

In some embodiments the metal catalyst is a Group 10 metal. In other embodiments the Group 10 metal catalyst is selected from nickel, platinum and palladium. In specific embodiments the Group 10 metal catalyst is palladium.

The invention also relates to methods of generating a carbon-carbon bond, comprising

a) reacting a compound of formula

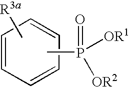

wherein
R¹ and R² are independently selected from H, (C₁-C₆) alkyl, benzyl and phenyl; and
R^{3a} is Sn(R¹⁰)(R¹¹)(R¹²) wherein R¹⁰, R¹¹ and R¹² are each (C₁-C₈) alkyl;
with an organic electrophile selected from an aryl halide, aryl triflate and aryl sulfonate;
in the presence of a metal catalyst selected from a Group 8, Group 9 and Group 10 metal. In certain embodiments, the method further comprises recovering a compound comprising said carbon-carbon bond.

In some embodiments the metal catalyst is a Group 10 metal. In other embodiments the Group 10 metal catalyst is selected from nickel, platinum and palladium. In specific embodiments the Group 10 metal catalyst is palladium.

Furthermore, the invention also relates to methods of generating a carbon-carbon bond, comprising
a) reacting a compound of formula

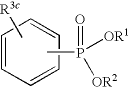

wherein
R¹ and R² are independently selected from H, (C₁-C₆) alkyl, benzyl and phenyl; and R^{3c} is [Si(R¹⁶)(R¹⁷)(R¹⁸)X]⁻M⁺ wherein R¹⁶ is OH or (C₁-C₆) alkoxy; R¹⁷ and R¹⁸ are independently selected from H, OH, (C₁-C₆) hydrocarbon and (C₁-C₆) alkoxy; X is selected from the group consisting of F, OAc, OR, OSiCH₃; M⁺ is a counterion; and R is selected from (C₁-C₆) alkyl;
with an organic electrophile selected from an aryl halide, aryl triflate and aryl sulfonate;
in the presence of a metal catalyst selected from a Group 8, Group 9 and Group 10 metal.

In certain embodiments, X is F. In other embodiments, X is OR. In certain embodiments thereof R is methyl.

In certain embodiments, the method further comprises recovering a compound comprising said carbon-carbon bond.

In some embodiments the metal catalyst is a Group 10 metal. In other embodiments the Group 10 metal catalyst is selected from nickel, platinum and palladium. In specific embodiments the Group 10 metal catalyst is palladium.

Additionally, the invention relates to methods of generating a carbon-carbon bond, comprising
a) reacting a compound of formula

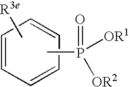

wherein
R¹ and R² are independently selected from H, (C₁-C₆) alkyl, benzyl and phenyl; and
R^{3e} is [Sn(R¹⁹)(R²⁰)(R²¹)X]⁻M⁺ wherein R¹⁹, R²⁰ and R²¹ are independently selected from (C₁-C₈) alkyl and X is selected from the group consisting of halogen, OAc, OR, and OSiCH₃ wherein R is selected from (C₁-C₆) alkyl and M⁺ is a counterion;
with an organic electrophile selected from an aryl halide, aryl triflate and aryl sulfonate;
in the presence of a metal catalyst selected from a Group 8, Group 9 and Group 10 metal.

In certain embodiments, X is F. In other embodiments, X is OR. In certain embodiments thereof R is methyl.

In certain embodiments, the method further comprises recovering a compound comprising said carbon-carbon bond.

In some embodiments the metal catalyst is a Group 10 metal. In other embodiments the Group 10 metal catalyst is selected from nickel, platinum and palladium. In specific embodiments the Group 10 metal catalyst is palladium.

It is to be understood that the method of the invention may be carried out in part or in full in a solid phase or in solution. Non-limiting examples showing the introduction of carbon-carbon bonds on solid support utilizing the Suzuki, Heck and Stille reactions are taught by Franzén (Franzén R., Can J. Chem. 78:957-62, 2000).

Furthermore, the method of the invention may be carried out by conventional synthetic methods or in part or in full using microwave irradiation; following procedures including those disclosed in U.S. Pat. No. 6,136,157.

### DEFINITIONS

Throughout this specification the terms and substituents retain their definitions.

Alkyl is intended to include linear, branched, or cyclic hydrocarbon structures and combinations thereof. When not otherwise restricted, the term refers to alkyl of 20 or fewer carbons. Lower alkyl refers to alkyl groups of 1, 2, 3, 4, 5 and 6 carbon atoms. Examples of lower alkyl groups include methyl, ethyl, propyl, isopropyl, butyl, s- and t-butyl and the like. Preferred alkyl and alkylene groups are those of C₂₀ or below (e.g. C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀). Cycloalkyl is a subset of alkyl and includes cyclic hydrocarbon groups of 3, 4, 5, 6, 7, and 8 carbon atoms. Examples of cycloalkyl groups include c-propyl, c-butyl, c-pentyl, norbornyl, adamantyl and the like.

C₁ to C₂₀ hydrocarbon (e.g. C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀) includes alkyl, cycloalkyl, alkenyl, alkynyl, aryl and combinations thereof. Examples include benzyl, phenethyl, cyclohexylmethyl, camphoryl and naphthylethyl.

Alkoxy or alkoxyl refers to groups of 1, 2, 3, 4, 5, 6, 7 or 8 carbon atoms of a straight, branched, cyclic configuration and combinations thereof attached to the parent structure through an oxygen. Examples include methoxy, ethoxy, propoxy, isopropoxy, cyclopropyloxy, cyclohexyloxy and the like. Lower-alkoxy refers to groups containing one to four carbons.

Oxaalkyl refers to alkyl residues in which one or more carbons (and their associated hydrogens) have been replaced by oxygen. Examples include methoxypropoxy, 3,6,9-trioxadecyl and the like. The term oxaalkyl is intended as it is understood in the art [see Naming and Indexing of Chemical Substances for Chemical Abstracts, published by the American Chemical Society, ¶196, but without the restriction of ¶127(a)], i.e. it refers to compounds in which the oxygen is bonded via a single bond to its adjacent atoms (forming ether bonds). Similarly, thiaalkyl and azaalkyl refer to alkyl residues in which one or more carbons have been replaced by sulfur or nitrogen, respectively. Examples include ethylaminoethyl and methylthiopropyl.

Acyl refers to groups of 1, 2, 3, 4, 5, 6, 7 and 8 carbon atoms of a straight, branched, cyclic configuration, saturated, unsaturated and aromatic and combinations thereof, attached to the parent structure through a carbonyl functionality. One or more carbons in the acyl residue may be replaced by nitrogen, oxygen or sulfur as long as the point of attachment to the parent remains at the carbonyl. Examples include formyl, acetyl, propionyl, isobutyryl, t-butoxycarbonyl, benzoyl, benzyloxycarbonyl and the like. Lower-acyl refers to groups containing one to four carbons.

Aryl and heteroaryl refer to aromatic or heteroaromatic rings, respectively, as substituents. Heteroaryl contains one, two or three heteroatoms selected from O, N, or S. Both refer to monocyclic 5- or 6-membered aromatic or heteroaromatic rings, bicyclic 9- or 10-membered aromatic or heteroaromatic rings and tricyclic 13- or 14-membered aromatic or heteroaromatic rings. Aromatic 6, 7, 8, 9, 10, 11, 12, 13 and 14-membered carbocyclic rings include, e.g., benzene, naphthalene, indane, tetralin, and fluorene and the 5, 6, 7, 8, 9 and 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole.

Arylalkyl means an alkyl residue attached to an aryl ring. Examples are benzyl, phenethyl and the like.

Substituted alkyl, aryl, cycloalkyl, heterocyclyl etc. refer to alkyl, aryl, cycloalkyl, or heterocyclyl wherein up to three H atoms in each residue are replaced with halogen, haloalkyl, hydroxy, loweralkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, heteroaryl, phenoxy, benzyloxy, or heteroaryloxy.

The term “halogen” or “halo” means fluorine, chlorine, bromine or iodine.

Group 1 salts include lithium, sodium, potassium and cesium salts. Group 2 salts include magnesium and calcium salts. Examples of ammonium salts include tetrabutylammonium and trimethylbenzylammonium.

The variables are defined when introduced and retain that definition throughout. Thus, for example, R¹ is always chosen from H, (C₁-C₆) alkyl, benzyl, phenyl, Group 1 salts, Group 2 salts and ammonium salts; although, according to standard patent practice, in dependent claims it may be restricted to a subset of these values.

In certain embodiments the organometal benzene phosphonate is a hypervalent silicate intermediate, such as those of formula IV. Silicate anions such as tetrabutylammonium triphenyl difluorosilicate have been shown to undergo metal-catalyzed coupling with aryl halides and aryl triflates. For example, a phenyl siloxane derivative treated with tetrabutylammonium fluoride yields a hypervalent fluorosilicate anion, which is able to undergo cross-coupling with an aryl halide to yield a biaryl compound (Mowry and DeShong, J. Org. Chem. 64:1684-88, 1999).

In a non-limiting example, M⁺ is a cation counterion selected from a Group 1 cation (e.g. Li, Na, K, Cs); a Group 2 cation (e.g. Mg, Ca); and ammonium salts including tetrabutylammonium and trimethylbenzylammonium.

A metal catalyst is preferably selected from a Group 8, Group 9, or Group 10 transition metal that is, a metal selected from iron, cobalt, nickel, ruthenium, rhodium, palladium, osmium, iridium, and platinum. In some embodiments the metal catalyst is selected from a Group 10 transition metal. Group 10 metal is palladium, platinum, or nickel, and usually, palladium. The Group 10 metal may exist in any oxidation state ranging from the zero-valent state to any higher variance available to the metal. Examples of catalysts for condensations are: palladium acetate, palladium chloride, palladium bromide, palladium acetylacetonate, bis(tri-o-tolyl)phosphine palladium dichloride, bis(triphenylphosphine)palladium dichloride, tetrakis(triphenylphosphine)palladium [(Ph₃P)₄Pd], dichloro[1,1′-bis(diphenylphosphino)ferrocene]palladium(II) dichloromethane adduct, and bis(dibenzylideneacetone)palladium [(dba)₂Pd]. Metal catalysts are commercially available and are familiar to those with skill in the art.

Conditions for metal catalyzed couplings are described with references in Diederich and Stang, Metal-Catalyzed Cross-Coupling Reactions; Wiley-VCH (1998).

The method of the present invention is not intended to be limited by the choice of an organic electrophile. The organic electrophile may be selected from an aryl halide and an aryl sulfonate, such as triflate (trifluoromethanesulfonate). Other acceptable organic electrophiles include organometallic electrophiles and aliphatic electrophiles.

The configuration of any carbon-carbon double bond appearing herein is selected for convenience only and is not intended to designate a particular configuration; thus a carbon-carbon double bond depicted arbitrarily herein as E may be Z, E, or a mixture of the two in any proportion.

Terminology related to “protecting”, “deprotecting” and “protected” functionalities is well understood by persons of skill in the art and is used in the context of processes, which involve sequential treatment with a series of reagents. In that context, a protecting group refers to a group which is used to mask a functionality during a process step in which it would otherwise react, but in which reaction is undesirable. The protecting group prevents reaction at that step, but may be subsequently removed to expose the original functionality. The removal or “deprotection” occurs after the completion of the reaction or reactions in which the functionality would interfere. Thus, when a sequence of reagents is specified, as it is in the processes of the invention, the person of ordinary skill can readily envision those groups that would be suitable as “protecting groups”. Suitable groups for that purpose are discussed in standard textbooks in the field of chemistry, such as Protective Groups in Organic Synthesis by T. W. Greene and Peter G. M. Wuts [John Wiley & Sons, New York, 1999], which is incorporated herein by reference.

The abbreviations Me, Et, Ph, Tf, Ts and Ms represent methyl, ethyl, phenyl, trifluoromethanesulfonyl, toluenesulfonyl and methanesulfonyl respectively. A comprehensive list of abbreviations utilized by organic chemists (i.e. persons of ordinary skill in the art) appears in the first issue of each volume of the Journal of Organic Chemistry. The list, which is typically presented in a table entitled “Standard List of Abbreviations” is incorporated herein by reference.

### EXAMPLES

The following examples are to be considered merely as illustrative and non-limiting in nature. It will be apparent to one skilled in the art to which the present invention pertains that many modifications, permutations, and variations may be made without departing from the scope of the invention.

In general, the compounds of the present invention may be prepared by the methods illustrated in the general reaction schemes as, for example, described below, or by modifications thereof, using readily available starting materials, reagents and conventional synthesis procedures. In these reactions, it is also possible to make use of variants that are in themselves known, but are not mentioned here.

### Example 1

### Preparation of diethyl[4-(4,4,5,5-tetramethyl-1,3,2-dioxaborolan-2-yl)phenyl]phosphonate (4)

The Grignard reagent derived from the reaction of magnesium and para-dibromobenzene (1) is reacted with diethyl chlorophosphate according to the procedure of Edder et al. [Org. Lett. 2003, 5, 1879-1882] to give diethyl 4-bromophenylphosphonate (2). Conversion of 2 to the corresponding pinacol boronate ester 4 is accomplished by reaction with bis(pinicolato)diboron (A) under the influence of palladium catalysis, essentially according to the procedure of Ishiyama et al. [J. Org. Chem. 1995, 60, 7508-7510]. (For additional references on the palladium catalyzed cross coupling see: A. Furstner, G. Seidel Org. Lett. 2002, 4, 541-543 and T. Ishiyama, M. Murata, T. Ahiko, N. Miyaura Org. Synth. 2000, 77, 176-185).

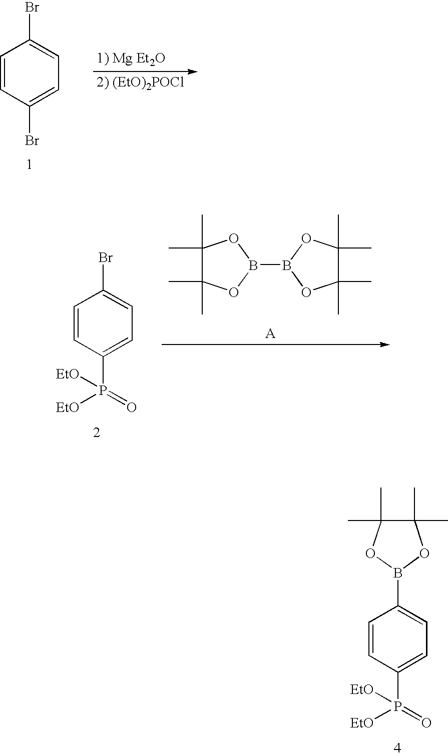

### Example 2

### Synthesis of Dimethyl[4-(4,4,5,5-tetramethyl-1,3,2-dioxaborolan-2-yl)phenyl]phosphonate (3)

A suspension of commercially available 4-bromophenyl boronic acid (18, 253.0 g, 1.24 mol) in acetonitrile (1000 ml) was stirred at room temperature. Pinacol (150.9 g, 1.27 mol) was added and stirring was continued 1.5 h until a clear solution was obtained. The solvent was removed at 30°-35° C. under vacuum to give crude 4-bromo-(4,4,5,5-tetramethyl-1,3,2-dioxaborolan-2-yl)benzene (20, 349.9 g, 99.7% yield) as light yellow solid; (¹H NMR (300 MHz, CDCl₃) δ 7.66 (d, J=8.4 Hz, 2H), 7.50 (d, J=8.4 Hz, 2 Hz), 1.34 (s, 12H) ppm). Crude 4-bromo-(4,4,5,5-tetramethyl-1,3,2-dioxaborolan-2-yl)benzene (20, 74.3 g, 93.5%, 0.245 mol) was dissolved in toluene (300 mL, 0.82 M). To the solution was added trimethyl phosphite (94.0 mL, 0.797 mol) via funnel and the reaction was heated to 105° C. A solution of 1,1′-Azobis-cyclohexane carbonitrile (ACBN, 9.8 g, 0.04 mol, alternatively, AIBN (2,2′-azobisisobutyronitrile) can be used) and tris(trimethylsilyl)silane (97.2 mL, 0.315 mol) in toluene (200 mL) was added to the flask drop-wise over 4.5 hours at a rate of 1 mL/minute.

Toluene was removed by distillation under vacuum, hexane (200 ml) was added and the reaction mixture was stirred at ambient temperature for 12 hours, then in an ice-water bath for 2 hours. The solid was filtered and washed with cold hexane (150 mL), air dried, then vacuum dried to constant weight to afford dimethyl[4-(4,4,5,5-tetramethyl-1,3,2-dioxaborolan-2-yl)phenyl]phosphonate (3, 46.0 g, 56% yield) as a light cream-colored crystalline solid; mp 84.2±0.8° C.; R_{f} 0.29 (2:1 ethyl acetate-hexane); hplc 2.06 min; NMR purity >99 A %; ¹H NMR (300 MHz, CDCl₃) δ 7.89 (dd, J=8.2, 4.6 Hz, 2H), 781 (dd, J=13.2, 8.2 Hz, 2H), 3.75 (s, 3H), 3.72 (s, 3H), 1.34 (s, 12H) ppm; MS [M+H] 312, [2M+H] 625.

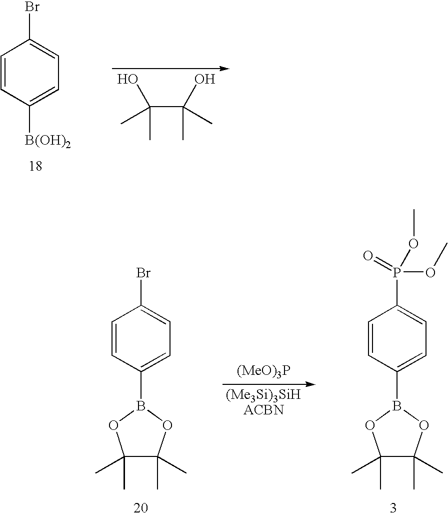

Alternatively reaction conditions of dimethyl phosphite with triethylamine in the presence of tetrakis[triphenyl phospine]palladium (0) can be used to synthesize compound 3 from compound 20.

### Example 3

### Preparation of a Tin Containing Aryl Phosphonate

Coupling of 2 with hexabutylditin (5) with a palladium catalyst, such as (Ph₃P)₄Pd, provides diethyl[4-(tributylstannyl)phenyl]phosphonate (6). This is an adaptation of the procedure of Kosugi et al. (Chem. Lett. 6, 829-830, 1981).

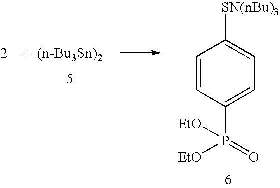

### Example 4

### Synthesis of diethyl {4-[hydroxy(dimethyl)silyl]phenyl}phosphonate (9)

Commercially available 4-(diethoxyphosphoryl)benzoic acid (7a) is converted into the corresponding acid chloride (7b) with thionyl chloride. Reaction of 7b with 1,2-dichlorotetramethyldisilane in the presence of a palladium catalyst, such as bis(benzonitrile)palladium chloride and triphenylphosphine, promotes silylative decarbonylation and the formation of diethyl {4-[chloro(dimethyl)silyl]phenyl}phosphonate (8). This is an adaptation of the procedure of Rich (J. Am. Chem. Soc. 111:886-5893, 1991). Hydrolysis of 8 then produces the corresponding hydroxy derivative 9.

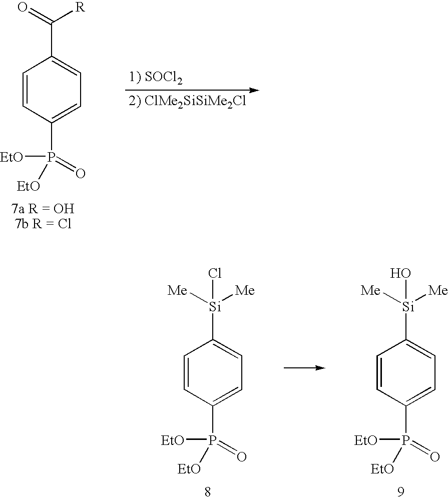

### Example 5

### Preparation of an Organozinc Derivative and its Use for the Preparation of an Organoboron Derivative

Reaction of 2 with activated zinc (prepared according to the procedure of Zhu et al. [J. Org. Chem. 56:1445-1453, 1991) gives bromo[4-(diethoxyphosphoryl)phenyl]zinc (10). Coupling of 2-chloro-5,5-dimethyl-1,3,2-dioxaborinane (11), (prepared by the published procedure; U.S. Pat. No. 3,064,032), with 10 gives diethyl[4-(5,5-dimethyl-1,3,2-dioxaborinan-2-yl)phenyl]phosphonate (12). Reaction of 10 with 2-chloro-4,4,5,5-tetramethyl-1,3,2-dioxaborolane provides 4.

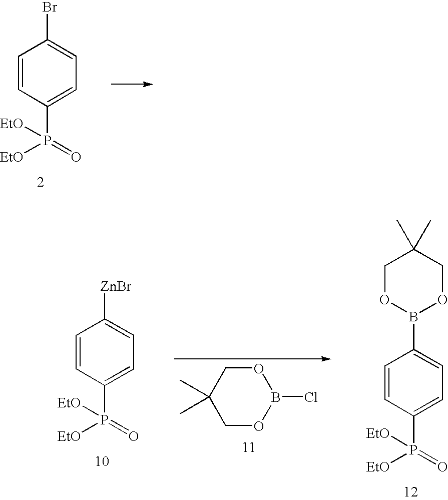

### Example 6

### Preparation of diethyl(3-bromophenyl)phosphonate (14) from 1,3-dibromobenzene (13)

Using the procedure of Hirao et al. (Synthesis 1:56-57, 1981), 13 is coupled with diethylphosphite in the presence of triethylamine and (Ph₃P)₄Pd to give 14.

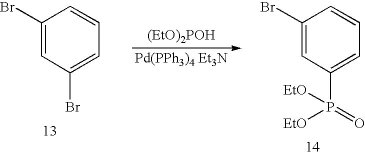

### Example 7

### Preparation of diethyl[3-(dimethoxyboryl)phenyl]phosphonate (15)

Treatment of 14 with n-butyllithium in tetrahydrofuran at low temperature produces the corresponding organolithium, which is condensed with trimethylborate to give 15.

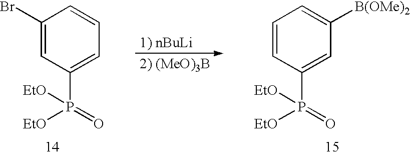

### Example 8

### Preparation of diethyl[3-(trimethoxysilyl)phenyl]phosphonate (16)

Treatment of 14 with n-butyllithium in tetrahydrofuran at low temperature produces the corresponding organolithium that is condensed with tetramethyl orthosilicate to give 16.

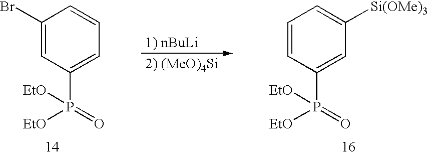

### Example 9

### Preparation of diethyl[3-(4,4,5,5-tetramethyl-1,3,2-dioxaborolan-2-yl)phenyl]phosphonate (17)

Treatment of 14 with 4,4,5,5-tetramethyl-1,3,2-dioxaborolane in the presence of a palladium catalyst gives 17. (See the published procedures; C. Christophersen, M. Begtrup, S. Ebdrup, H. Petersen, P. Vedso J. Org. Chem. 68:9513-9516, 2003; P. E. Broutin, I. Cerna, M. Campaniello, F. Leroux, F. Colobert Org. Lett. 4419-4422, 2004; M. Murata, T. Oyama, S. Watanabe, Y. Masuda J. Org. Chem. 65:164-168, 2004)

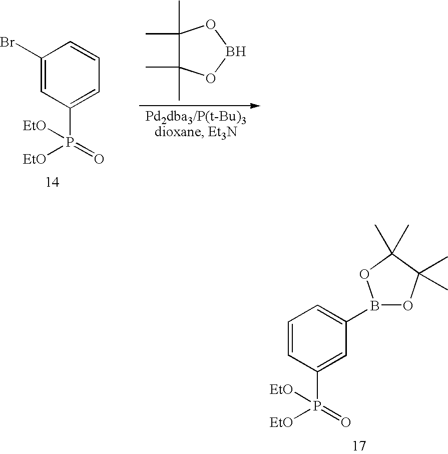

### Example 10

### Preparation of [4-(dimethoxyphosphoryl)phenyl]boronic acid (19)

Treatment of commercially available 4-bromophenylboronic acid (18) with trimethylphosphite in boiling toluene containing 2,2′-azobis(2-methylpropionitrile) (AIBN) and tributyltin hydride gave 19. ¹H NMR (300 MHz, CDCl₃) δ 7.45-7.80 (m, 4H), 3.78 (d, J=0.70 Hz, 3H), 3.74 (d, J=0.70 Hz, 3H) ppm (See Jiao, X. Y.; Bentrude, W. G. J. Org. Chem. 68:3303-3306, 2003).

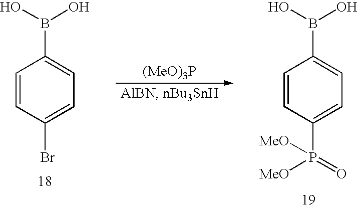

### Example 11

### Preparation of dimethyl[4-(4,4,5,5-tetramethyl-1,3,2-dioxaborolan-2-yl)phenyl]phosphonate (3)

Reaction of 19 with pinacol gave compound 3. (See Jiao, X. Y.; Bentrude, W. G. J. Org. Chem. 68:3303-3306, 2003). ¹H NMR (300 MHz, CDCl₃) δ 7.89 (dd, J=4.5, 8.2 Hz, 2H), 7.78 (dd, J=8.2, 13.1 Hz, 2 Hz), 3.75 (s, 3H) 3.72 (s, 3H) 1.35 (s, 12H) ppm

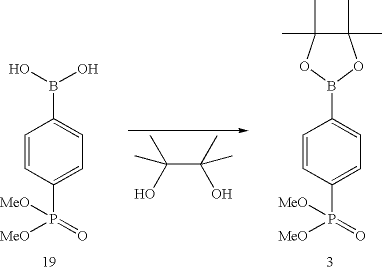

### Example 12

### Preparation of [4-(4,4,5,5-tetramethyl-1,3,2-dioxaborolan-2-yl)phenyl]phosphonic acid (21)

Crude pinacol ester 20, synthesis described above, (210.0 g, 0.742 mol) was dissolved in chlorobenzene (500 mL, 1.48 M), trimethyl phosphite (270.7 mL, 2.23 mol) was added via addition funnel and the reaction was heated to 110° C. A solution of 1,1′-azobis-cyclohexane carbonitrile (19.9 g, 0.082 mol) and tri-n-butyltin hydride (235.7 mL, 0.85 mol) in chlorobenzene (250 mL) was added drop-wise to the flask over 4.5 hours. The mixture was stirred for 1.5 hours at 110° C. then heating was discontinued, potassium fluoride (172.4 g, 2.97 mol) and water (53.42 ml, 2.97 mol) were added and reaction was stirred overnight at ambient temperature. Sodium sulfate (50 g) was added and the mixture was filtered through a pad of Celite® and sodium sulfate. The cake was washed with dichloromethane (2×750 ml) and the combined filtrates were concentrated under vacuum to obtain crude dimethyl[4-(4,4,5,5-tetramethyl-1,3,2-dioxaborolan-2-yl)phenyl]phosphonate 3 as a yellow solid. A 3-L flask was charged with crude 3 (theory 0.742 mol) at room temperature. Anhydrous dichloromethane (740 ml) and bromotrimethylsilane (225.2 ml, 1.71 mol) were added in succession via additional funnel. The mixture was stirred at ambient temperature for 2 hours, then water (53.2 ml, 3.34 mol) was added and stirring was continued for another hour. The solvents were removed in vacuo to give the crude phosphonic acid 21 as a yellow colored solid. The crude product was recrystallized from tert-butyl methyl ether (750 mL) to give [4-(4,4,5,5-tetramethyl-1,3,2-dioxaborolan-2-yl)phenyl]phosphonic acid (21, 132.5 g, 63% yield); ¹H NMR (300 MHz, CD₃OD) δ 7.72-7.87 (m, 4H), 1.35 (s, 12H) ppm.

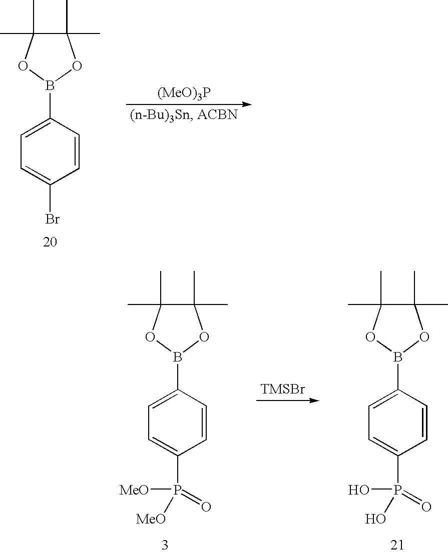

### Example 13

### Dimethyl(3′-{[tert-butyl(dimethyl)silyl]oxy}-4′-{(2S,3R)-3-[(3S)-3-{[tert-butyl(dimethyl)silyl]oxy}-3-(4-fluorophenyl)propyl]-4-oxo-1-phenylazetidin-2-yl}biphenyl-3-yl)phosphonate

(3R,4S)-4-(4-Bromo-2-{[tert-butyl(dimethyl)silyl]oxy}phenyl)-3-[(3S)-3-{[tert-butyl(dimethyl)silyl]oxy}-3-(4-fluorophenyl)propyl]-1-phenylazetidin-2-one (0.080 g, 0.11 mmol), crude dimethyl [3-(4,4,5,5-tetramethyl-1,3,2-dioxaborolan-2-yl)phenyl]phosphonate (0.054 g total, 0.030 g calculated, 0.096 mmol) and aqueous 2 M potassium carbonate (0.12 mL, 0.24 mmol) were mixed in ethanol (1.0 mL) and toluene (3.0 mL). The solution was deoxygenated by bubbling nitrogen through the mixture for 5 min while stirring. Tetrakis(triphenylphosphine)palladium(0) (0.05 g) was added and the reaction was heated for 3 h at 70° C. under an atmosphere of nitrogen. The reaction was cooled to room temperature, diluted with ethyl acetate, washed with water and brine, dried over sodium sulfate and concentrated by rotary evaporation under reduced pressure. The product was purified by chromatography over silica gel using ethyl acetate-hexane (gradient: 10% ethyl acetate to 80%) to afford dimethyl (3′-{[tert-butyl(dimethyl)silyl]oxy}-4′-{(2S,3R)-3-[(3S)-3-{[tert-butyl(dimethyl)silyl]oxy}-3-(4-fluorophenyl)propyl]-4-oxo-1-phenylazetidin-2-yl}biphenyl-3-yl)phosphonate as a colorless syrup (0.065 g, 84%). ¹H NMR (300 MHz, CDCl₃) δ 6.9-8.0 (m, 16H), 5.09 (d, J=2.2 Hz, 1H), 4.64 (d, J=6.1 Hz, 1H), 3.79 (d, J=2.4 Hz, 3H), 3.76 (d, J=2.4 Hz, 3H), 3.05-3.15 (m, 1H), 1.8-2.0 (m, 4H), 1.06 (s, 9H), 0.85 (s, 9H), 0.36 (s, 3H), 0.33 (s, 3H), 0.00 (s, 3H), −0.20 (s, 3H) ppm

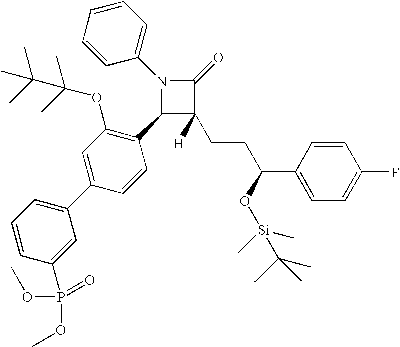

While the present invention has been particularly described, persons skilled in the art will appreciate that many variations and modifications can be made. Therefore, the invention is not to be construed as restricted to the particularly described embodiments, rather the scope, spirit and concept of the invention will be more readily understood by reference to the claims which follow.

We claim:

1. A compound of formula I 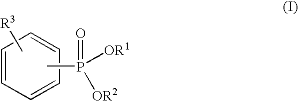
wherein
R¹ and R² are independently selected from H, (C₁-C₆) alkyl, phenyl, benzyl, Group 1 salts, Group 2 salts, and ammonium salts; and
R³ is selected from the group consisting of
ZnX wherein X is halogen; and
B(OR⁴)(OR⁵), wherein R⁴ and R⁵ are independently selected from H and (C₁-C₆) alkyl, or R⁴ and R⁵ together form a 5-6 membered ring.

2. The compound according to claim 1 wherein R³ is B(OR⁴)(OR⁵), of formula:

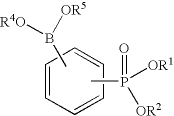

3. The compound according to claim 2 wherein R¹, R², R⁴ and R⁵ are H, of formula:

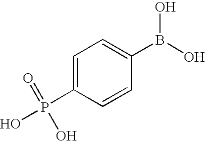

4. The compound according to claim 2 wherein R⁴ and R⁵ together form a 5-membered saturated ring, of formula: 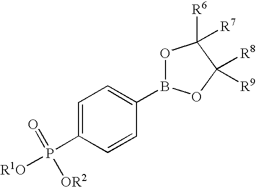
wherein
R⁶, R⁷, R⁸ and R⁹ are independently selected from H and (C₁-C₆) alkyl.

5. The compound according to claim 4 wherein R¹, R², R⁶, R⁷, R⁸ and R⁹ are methyl, of formula:

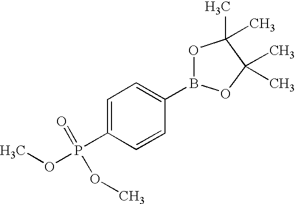

6. The compound according to claim 4 wherein R¹ and R² are H; and R⁶, R⁷, R⁸ and R⁹ are methyl, of formula:

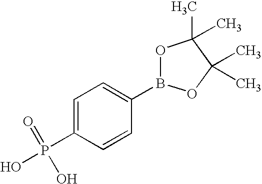

7. The compound according to claim 2 wherein R⁴ and R⁵ together form a 6-membered saturated ring, of formula: 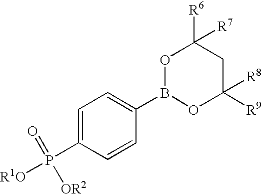
wherein R⁶, R⁷, R⁸ and R⁹ are independently selected from H and (C₁-C₆) alkyl.

8. A compound according to claim 2 wherein R⁴ and R⁵ together form a 6-membered saturated ring, of formula: 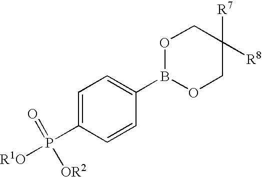
wherein R⁷ and R⁸ are independently selected from H and (C₁-C₆) alkyl.

9. The compound of claim 8 wherein R¹ and R² are ethyl; and R⁷ and R⁸ are methyl, of formula:

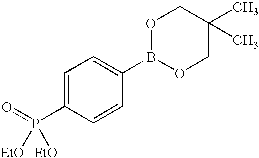

10. The compound according to claim 1 wherein R³ is ZnX, of formula:

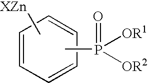

11. The compound according to claim 10 wherein R¹ and R² are CH₃.

12. A compound of formula II: 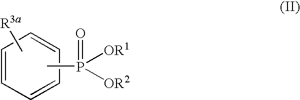
wherein
R¹ and R² are independently selected from H, (C₁-C₆) alkyl, benzyl and phenyl; and
R^{3a} is Sn(R¹⁰)(R¹¹)(R¹²) wherein R¹⁰, R¹¹ and R¹² are each (C₁-C₈) alkyl.

13. The compound according to claim 12 wherein R¹ and R² are independently selected from H, methyl and ethyl.

14. The compound according to claim 12, wherein R¹⁰, R¹¹ and R¹² are n-butyl, of formula:

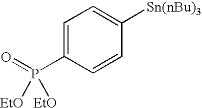

15. A compound of formula III: 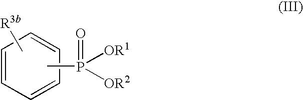
wherein
R¹ and R² are independently selected from H, (C₁-C₆) alkyl, benzyl and phenyl; and
R^{3b} is Si(R¹³)(R¹⁴)(R¹⁵) wherein R¹³ is selected from OH and (C₁-C₆) alkoxy; R¹⁴ and R¹⁵ are independently selected from (C₁-C₆) hydrocarbon and (C₁-C₆) alkoxy;
with the proviso that when R¹ and R² are both CH₂CH₃, then R¹³, R¹⁴ and R¹⁵ are other than ethyloxy.

16. The compound according to claim 15 wherein R¹ and R² are independently selected from H, methyl and ethyl.

17. The compound according to claim 15 wherein R¹³, R¹⁴ and R¹⁵ are OCH₃.

18. The compound according to claim 15 wherein R¹³ is OCH₃; and R¹⁴ and R¹⁵ are CH₃.

19. The compound according to claim 16 wherein R¹ and R² are ethyl, R¹³ is OH; and R¹⁴ and R¹⁵ are CH₃ of formula:

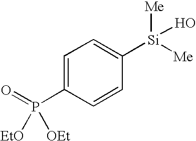

20. A compound of formula IV
(IV) 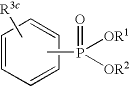
wherein
R¹ and R² are independently selected from H, (C₁-C₆) alkyl, benzyl and phenyl; and
R^{3c} is [Si(R¹⁶)(R¹⁷)(R¹⁸)X]⁻M⁺ wherein R¹⁶ is OH or (C₁-C₆) alkoxy; R¹⁷ and R¹⁸ are independently selected from H, OH, (C₁-C₆) hydrocarbon and (C₁-C₆) alkoxy; X is selected from the group consisting of F, OAc, OR, OSiCH₃; M⁺ is a counterion and R is selected from (C₁-C₆) alkyl.

21. The compound according to claim 20 wherein R¹⁶, R¹⁷ and R¹⁸ are OCH₃.

22. The compound according to claim 20 wherein R¹⁶ is OCH₃; and R¹⁷ and R¹⁸ are CH₃.

23. A compound of formula V 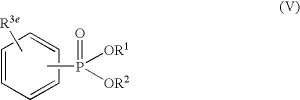
wherein
R¹ and R² are independently selected from H, (C₁-C₆) alkyl, benzyl and phenyl; and
R^{3e} is [Sn(R¹⁹)(R²⁰)(R²¹)X]⁻M⁺ wherein R¹⁹, R²⁰ and R²¹ are independently selected from (C₁-C₈) alkyl; and X is selected from the group consisting of halogen, OAc, OR, and OSiCH₃ wherein R is selected from (C₁-C₆) alkyl and M⁺ is a counterion.

24. The compound according to claim 23 wherein R¹⁹, R²⁰ and R²¹ are C₄H₉.

25. (canceled)

26. (canceled)

27. (canceled)

28. A method of generating a carbon-carbon bond comprising reacting a compound according to claim 1 with an organic electrophile selected from an aryl halide, aryl triflate and aryl sulfonate; in the presence of a metal catalyst selected from a Group 8, Group 9 and Group 10 metal.

29. A method of generating a carbon-carbon bond, comprising reacting a compound of formula 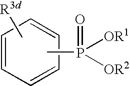
wherein
R¹ and R² are independently selected from H, (C₁-C₆) alkyl, benzyl and phenyl;
and R^{3d} is Si (R¹⁹)(R²⁰)(R²¹) wherein R¹⁹ is selected from OH and (C₁-C₆) alkoxy; and R²⁰ and R²¹ are independently selected from H, (C₁-C₆) hydrocarbon and (C₁-C₆) alkoxy;
with an organic electrophile selected from an aryl halide, aryl triflate and aryl sulfonate;
in the presence of a metal catalyst selected from a Group 8, Group 9 and Group 10 metal.

30. (canceled)

31. A method of generating a carbon-carbon bond, comprising reacting a compound of formula 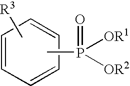
wherein
R¹ and R² are independently selected from H, (C₁-C₆) alkyl, phenyl, benzyl, Group 1 salts, Group 2 salts, and ammonium salts;
R³ is selected from the group consisting of
ZnX wherein X is halogen; and
B(OR⁴)(OR⁵), wherein R⁴ and R⁵ are independently selected from H and (C₁-C₆) alkyl, or R⁴ and R⁵ together form a 5-6 membered ring;
with an organic electrophile selected from an aryl halide, aryl triflate and aryl sulfonate;
in the presence of a metal catalyst selected from a Group 8, Group 9 and Group 10 metal.

32. A method of generating a carbon-carbon bond, comprising reacting a compound of formula 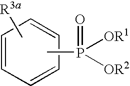
wherein
R¹ and R² are independently selected from H, (C₁-C₆) alkyl, benzyl and phenyl; and
R^{3a} is Sn(R¹⁰)(R¹¹)(R¹²) wherein R¹⁰, R¹¹ and R¹² are each (C₁-C₈) alkyl;
with an organic electrophile selected from an aryl halide, aryl triflate and aryl sulfonate;
in the presence of a metal catalyst selected from a Group 8, Group 9 and Group 10 metal.

33. A method of generating a carbon-carbon bond, comprising reacting a compound of formula 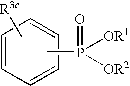
wherein
R¹ and R² are independently selected from H, (C₁-C₆) alkyl, benzyl and phenyl; and
R^{3c} is [Si(R¹⁶)(R¹⁷)(R¹⁸)X]⁻M⁺ wherein R¹⁶ is OH or (C₁-C₆) alkoxy; R¹⁷ and R¹⁸ are independently selected from H, OH, (C₁-C₆) hydrocarbon and (C₁-C₆) alkoxy; X is selected from the group consisting of F, OAc, OR, OSiCH₃; M⁺ is a counterion and R is selected from (C₁-C₆) alkyl.
with an organic electrophile selected from an aryl halide, aryl triflate and aryl sulfonate;
in the presence of a metal catalyst selected from a Group 8, Group 9 and Group 10 metal.

34. A method of generating a carbon-carbon bond, comprising reacting a compound of formula 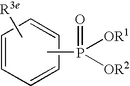
wherein
R¹ and R² are independently selected from H, (C₁-C₆) alkyl, benzyl and phenyl; and
R^{3e} is [Sn(R¹⁹)(R²⁰)(R²¹)X]⁻M⁺ wherein R¹⁹, R²⁰ and R²¹ are independently selected from (C₁-C₈) alkyl; and X is selected from the group consisting of halogen, OAc, OR, and OSiCH₃ wherein R is selected from (C₁-C₆) alkyl and M⁺ is a counterion;
with an organic electrophile selected from an aryl halide, aryl triflate and aryl sulfonate;
in the presence of a metal catalyst selected from a Group 8, Group 9 and Group 10 metal.

35. (canceled)

36. (canceled)

37. (canceled)

38. (canceled)

39. The method of either of claims 28 or 31 wherein the metal catalyst is a Group 10 metal.

40. The method of claim 39 wherein the Group 10 metal catalyst is selected from nickel, platinum and palladium.

41. The method of claim 40 wherein the Group 10 metal catalyst is palladium.

42. The method of either of claims 32 or 34 wherein the metal catalyst is a Group 10 metal.

43. The method of claim 42 wherein the Group 10 metal catalyst is selected from nickel, platinum and palladium.

44. The method of claim 43 wherein the Group 10 metal catalyst is palladium.

45. The method of either of claims 29 or 33 wherein the metal catalyst is a Group 10 metal.

46. The method of claim 45 wherein the Group 10 metal catalyst is selected from nickel, platinum and palladium.

47. The method of claim 46 wherein the Group 10 metal catalyst is palladium.
